(19) United States
(12) Patent Application Publication
(10) Pub. No.: US 2018/0297333 A1
(43) Pub. Date: Oct. 18, 2018

(54) Methods for Making Collapsed Bubble Film

(71) Applicant: ExxonMobil Chemical Patents Inc., Baytown, TX (US)

(72) Inventors: Carolina A. Cateto, Brussels (BE); Achiel J. M. Van Loon, Schoten (BE)

(21) Appl. No.: 15/895,385

(22) Filed: Feb. 13, 2018

Related U.S. Application Data
(60) Provisional application No. 62/484,699, filed on Apr. 12, 2017.

(51) Int. Cl. B32B 25/08; B32B 27/32; B32B 27/34; B32B 25/16; B32B 27/30; B29C 47/00; B29C 47/06

(52) U.S. Cl. CPC B32B 25/08; B29K 2023/0633; B32B 27/34; B32B 25/16; B32B 27/306; B29C 47/0021; B29C 47/065; B29C 47/0057; B32B 2250/05; B32B 2307/54; B32B 2307/558; B32B 2307/5825; B32B 2307/546; B32B 2553/00; B32B 27/32

(57) ABSTRACT

Disclosed are methods for making a multilayer collapsed bubble film comprising a propylene-based elastomer and films produced thereby.

### PRIORITY CLAIM

This application claims priority to and benefit of U.S. Ser. No. 62/484,699, filed Apr. 12, 2017, and is incorporated by reference in its entirety.

### FIELD OF THE INVENTION

This invention relates to a multilayer high barrier film formulations with high Elmendorf tear strength and bending stiffness properties.

### BACKGROUND OF THE INVENTION

Manufacturing of coextruded blown films and the equipment for making them are well known in the art. Multilayer films in which at least one surface or outer layer are made to facilitate heat-sealing are also known. A core film layer may be used to provide strength, impact resistance, stretchability, other physical properties of the film based on the intended end use. Layers between the outer layer and core layer, also referred to as inner layers, may facilitate the adhesion of the layers and/or may impart barrier properties against the transmission of moisture, carbon dioxide, oxygen, other gases and the like.

Polymers used in such processes for packaging applications generally include polyethylene, polypropylene, ethylene vinyl alcohol, and the like. Film properties are often subject to the combined effect of the coextrusion process conditions and polymer compositions selected for the different layers. Film producers have to balance mechanical properties, such as stiffness and impact strength, to make stronger films for a given thickness, and optical properties (such as clarity and haze) which impact the attractiveness of the packaging and visual inspection of the goods at the point of sale.

U.S. Publication No. 2015/0158235 relates to a method for making a multilayer film by a coextrusion line process. The process includes extruding a core layer from a first extruder, extruding two outer layers form a second extruder, and combining the core layer and the two outer layers to form a multilayer film. The core layer includes a propylene-based elastomer having at least about 60 wt % propylene-derived units and about 3 to about 25 wt % ethylene-derived units, based on total weight of the propylene-based elastomer, and a heat of fusion of less than about 80 J/g; is between the two outer layers; and has an equal number of layer(s) on both sides of it. At least one outer layer comprises from about 50 to about 100 wt % of a polyethylene. There is still a need for a multilayer film with high barrier film formulations with high Elmendorf tear strength and bending stiffness properties.

### SUMMARY OF THE INVENTION

In one aspect, embodiments herein describe a multilayer film, comprising three inner layers, three inner layers, wherein the three innerlayers are adjacent to one another and one of the outermost inner layers (inner layer A) consists essentially of a propylene-based elastomer having at least about 60 wt % propylene-derived units and about 3 to about 25 wt % ethylene-derived units, based on total weight of the propylene-based elastomer, and a heat of fusion of less than about 80 J/g; three outer layers, wherein each outer layer comprises a blend of two polyethylenes; and five core layers, wherein the two outermost layers of the five core layers comprise of a blend of an ethylene copolymer and an anhydride-modified linear low-density polyethylene, the innermost layer of the five core layers consists essentially of ethylene vinyl alcohol, and the layers in between the outermost layers and the innermost layer of the five core layers consists essentially of a polyamide; wherein the five core layers are in between the three inner layers and the three outer layers; and wherein inner layer A is not adjacent to the five core layers.

### BRIEF DESCRIPTION OF THE DRAWINGS

FIG. 1 depicts a spider chart of two comparative films and one inventive film.

FIG. 2 depicts the inventive film prepared, nipped, and collapsed.

### DETAILED DESCRIPTION OF THE PRESENT INVENTION

Various specific embodiments, versions of the present invention will now be described, including preferred embodiments and definitions that are adopted herein. While the following detailed description gives specific preferred embodiments, those skilled in the art will appreciate that these embodiments are exemplary only, and that the present invention can be practiced in other ways. Any reference to the “invention” may refer to one or more, but not necessarily all, of the present inventions defined by the claims. The use of headings is for purposes of convenience only and does not limit the scope of the present invention.

As used herein, a “polymer” may be used to refer to homopolymers, copolymers, interpolymers, terpolymers, etc. A “polymer” has two or more of the same or different monomer units. A “homopolymer” is a polymer having monomer units that are the same. A “copolymer” is a polymer having two or more monomer units that are different from each other. A “terpolymer” is a polymer having three monomer units that are different from each other. The term “different” as used to refer to monomer units indicates that the monomer units differ from each other by at least one atom or are different isomerically. Accordingly, the definition of copolymer, as used herein, includes terpolymers and the like. Likewise, the definition of polymer, as used herein, includes copolymers and the like. Thus, as used herein, the terms “polyethylene,” “ethylene polymer,” “ethylene copolymer,” and “ethylene based polymer” mean a polymer or copolymer comprising at least 50 mol % ethylene units (preferably at least 70 mol % ethylene units, more preferably at least 80 mol % ethylene units, even more preferably at least 90 mol % ethylene units, even more preferably at least 95 mol % ethylene units or 100 mol % ethylene units (in the case of a homopolymer)). Furthermore, the term “polyethylene composition” means a composition containing one or more polyethylene components.

As used herein, when a polymer is referred to as comprising a monomer, the monomer is present in the polymer in the polymerized form of the monomer or in the derivative form of the monomer.

As used herein, when a polymer is said to comprise a certain percentage, wt %, of a monomer, that percentage of monomer is based on the total amount of monomer units in the polymer.

As used herein, “elastomer” or “elastomeric composition” refers to any polymer or composition of polymers (such as blends of polymers) consistent with the ASTM D1566 definition. Elastomer includes mixed blends of polymers such as melt mixing and/or reactor blends of polymers.

For purposes of this invention, an ethylene polymer having a density of 0.86 g/cm³ or less is referred to as an “ethylene elastomer”; an ethylene polymer having a density of more than 0.86 to less than 0.910 g/cm³ is referred to as an “ethylene plastomer”; an ethylene polymer having a density of 0.910 to 0.940 g/cm³ is referred to as a “low density polyethylene” (LDPE); and an ethylene polymer having a density of more than 0.940 g/cm³ is referred to as a “high density polyethylene” (HDPE).

Polyethylene having a density of 0.890 to 0.930 g/cm³, typically from 0.915 to 0.930 g/cm³, that is linear and does not contain long-chain branching is referred to as “linear low density polyethylene” (LLDPE) and can be produced with conventional Ziegler-Natta catalysts, vanadium catalysts, or with metallocene catalysts in gas phase reactors and/or in slurry reactors and/or with any of the disclosed catalysts in solution reactors. “Linear” means that the polyethylene has no or only a few long-chain branches, typically referred to as a g′vis of 0.97 or above, preferably 0.98 or above.

As used herein, “core” layer, “outer” layer, and “inner” layer are merely identifiers used for convenience, and shall not be construed as limitation on individual layers, their relative positions, or the laminated structure, unless otherwise specified.

As used herein, when a film is referred to as “symmetrical”, it contains layers on one side of the core layer that are mirror images of those on the other side relative to the core layer.

As used herein, film layers that are the same in composition and in thickness are referred to as “identical” layers.

As used herein, a “comparative film” refers to a film free of the core layer comprising the propylene-based elastomer compared to the referenced film. The comparative films described here are not collapsed and therefore have 11 layers. The inventive films described here is collapsed and therefore has 21 layers.

As used herein, a film “free of” the core layer comprising the propylene-based elastomer described herein refers to a film substantially devoid of such core layer, or comprising such core layer in an amount of less than about 0.01%, by volume of the total film.

### Propylene-Based Elastomer

The propylene-based elastomer is a copolymer of propylene-derived units and units derived from at least one of ethylene or a C₄-C₁₀ alpha-olefin. The propylene-based elastomer may contain at least about 50 wt % propylene-derived units. The propylene-based elastomer may have limited crystallinity due to adjacent isotactic propylene units and a melting point as described herein. The crystallinity and the melting point of the propylene-based elastomer can be reduced compared to highly isotactic polypropylene by the introduction of errors in the insertion of propylene. The propylene-based elastomer is generally devoid of any substantial intermolecular heterogeneity in tacticity and comonomer composition, and also generally devoid of any substantial heterogeneity in intramolecular composition distribution.

The amount of propylene-derived units present in the propylene-based elastomer may range from an upper limit of about 95 wt %, about 94 wt %, about 92 wt %, about 90 wt %, or about 85 wt %, to a lower limit of about 60 wt %, about 65 wt %, about 70 wt %, about 75 wt %, about 80 wt %, about 84 wt %, or about 85 wt %, of the propylene-based elastomer.

The units, or comonomers, derived from at least one of ethylene or a C₄-C₁₀ alpha-olefin may be present in an amount of about 1 to about 35 wt %, or about 5 to about 35 wt %, or about 7 to about 30 wt %, or about 8 to about 25 wt %, or about 8 to about 20 wt %, or about 8 to about 18 wt %, of the propylene-based elastomer. The comonomer content may be adjusted so that the propylene-based elastomer has a heat of fusion of less than about 80 J/g, a melting point of about 105° C. or less, and a crystallinity of about 2% to about 65% of the crystallinity of isotactic polypropylene, and a fractional melt flow rate of about 0.5 to about 20 g/min.

In preferred embodiments, the comonomer is ethylene, 1-hexene, or 1-octene, with ethylene being most preferred. In embodiments where the propylene-based elastomer comprises ethylene-derived units, the propylene-based elastomer may comprise about 3 to about 25 wt %, or about 5 to about 20 wt %, or about 9 to about 18 wt % of ethylene-derived units. In some embodiments, the propylene-based elastomer consists essentially of units derived from propylene and ethylene, i.e., the propylene-based elastomer does not contain any other comonomer in an amount other than that typically present as impurities in the ethylene and/or propylene feedstreams used during polymerization, or in an amount that would materially affect the heat of fusion, melting point, crystallinity, or fractional melt flow rate of the propylene-based elastomer, or in an amount such that any other comonomer is intentionally added to the polymerization process.

In some embodiments, the propylene-based elastomer may comprise more than one comonomer. Preferred embodiments of a propylene-based elastomer having more than one comonomer include propylene-ethylene-octene, propylene-ethylene-hexene, and propylene-ethylene-butene polymers. In embodiments where more than one comonomer derived from at least one of ethylene or a C₄-C₁₀ alpha-olefin is present, the amount of one comonomer may be less than about 5 wt % of the propylene-based elastomer, but the combined amount of comonomers of the propylene-based elastomer is about 5 wt % or greater.

The propylene-based elastomer may have a triad tacticity of three propylene units, as measured by ¹³C NMR, of at least about 75%, at least about 80%, at least about 82%, at least about 85%, or at least about 90%. Preferably, the propylene-based elastomer has a triad tacticity of about 50 to about 99%, or about 60 to about 99%, or about 75 to about 99%, or about 80 to about 99%. In some embodiments, the propylene-based elastomer may have a triad tacticity of about 60 to 97%.

The propylene-based elastomer has a heat of fusion (“H_{f}”), as determined by DSC, of about 80 J/g or less, or about 70 J/g or less, or about 50 J/g or less, or about 40 J/g or less. The propylene-based elastomer may have a lower limit H_{f} of about 0.5 J/g, or about 1 J/g, or about 5 J/g. For example, the H_{f} value may range from a lower limit of about 1.0, 1.5, 3.0, 4.0, 6.0, or 7.0 J/g, to an upper limit of about 35, 40, 50, 60, 70, 75, or 80 J/g.

The propylene-based elastomer may have a percent crystallinity, as determined according to the DSC procedure described herein, of about 2 to about 65%, or about 0.5 to about 40%, or about 1 to about 30%, or about 5 to about 35%, of the crystallinity of isotactic polypropylene. The thermal energy for the highest order of propylene (i.e., 100% crystallinity) is estimated at 189 J/g. In some embodiments, the copolymer has crystallinity less than 40%, or in the range of about 0.25 to about 25%, or in the range of about 0.5 to about 22%, of the crystallinity of isotactic polypropylene.

Embodiments of the propylene-based elastomer may have a tacticity index m/r from a lower limit of about 4, or about 6, to an upper limit of about 8, or about 10, or about 12. In some embodiments, the propylene-based elastomer has an isotacticity index greater than 0%, or within the range having an upper limit of about 50%, or about 25%, and a lower limit of about 3%, or about 10%.

In some embodiments, the propylene-based elastomer may further comprise diene-derived units (as used herein, “diene”). The optional diene may be any hydrocarbon structure having at least two unsaturated bonds wherein at least one of the unsaturated bonds is readily incorporated into a polymer. For example, the optional diene may be selected from straight chain acyclic olefins, such as 1,4-hexadiene and 1,6-octadiene; branched chain acyclic olefins, such as 5-methyl-1,4-hexadiene, 3,7-dimethyl-1,6-octadiene, and 3,7-dimethyl-1,7-octadiene; single ring alicyclic olefins, such as 1,4-cyclohexadiene, 1,5-cyclooctadiene, and 1,7-cyclododecadiene; multi-ring alicyclic fused and bridged ring olefins, such as tetrahydroindene, norbornadiene, methyl-tetrahydroindene, dicyclopentadiene, bicyclo-(2.2.1)-hepta-2,5-diene, norbornadiene, alkenyl norbornenes, alkylidene norbornenes, e.g., ethylidiene norbornene (“ENB”), cycloalkenyl norbornenes, and cycloalkylene norbornenes (such as 5-methylene-2-norbornene, 5-ethylidene-2-norbornene, 5-propenyl-2-norbornene, 5-isopropylidene-2-norbornene, 5-(4-cyclopentenyl)-2-norbornene, 5-cyclohexylidene-2-norbornene, 5-vinyl-2-norbornene); and cycloalkenyl-substituted alkenes, such as vinyl cyclohexene, allyl cyclohexene, vinyl cyclooctene, 4-vinyl cyclohexene, allyl cyclodecene, vinyl cyclododecene, and tetracyclo (A-11,12)-5,8-dodecene. The amount of diene-derived units present in the propylene-based elastomer may range from an upper limit of about 15%, about 10%, about 7%, about 5%, about 4.5%, about 3%, about 2.5%, or about 1.5%, to a lower limit of about 0%, about 0.1%, about 0.2%, about 0.3%, about 0.5%, about 1%, about 3%, or about 5%, based on the total weight of the propylene-based elastomer.

The propylene-based elastomer may have a single peak melting transition as determined by DSC. In some embodiments, the copolymer has a primary peak transition of about 90° C. or less, with a broad end-of-melt transition of about 110° C. or greater. The peak “melting point” (“Tₘ”) is defined as the temperature of the greatest heat absorption within the range of melting of the sample. However, the copolymer may show secondary melting peaks adjacent to the principal peak, and/or at the end-of-melt transition. For the purposes of this disclosure, such secondary melting peaks are considered together as a single melting point, with the highest of these peaks being considered the Tₘ of the propylene-based elastomer. The propylene-based elastomer may have a Tₘ of about 110° C. or less, about 105° C. or less, about 100° C. or less, about 90° C. or less, about 80° C. or less, or about 70° C. or less. In some embodiments, the propylene-based elastomer has a Tₘ of about 25 to about 110° C., or about 40 to about 105° C., or about 60 to about 105° C.

For purposes of the invention, unless otherwise specified heat of fusion and melting point (Tₘ) values are determined by differential scanning calorimetry (DSC) in accordance with the following procedure. From about 6 mg to about 10 mg of a sheet of the polymer pressed at approximately 200° C. to 230° C. is removed with a punch die. This is annealed at room temperature for at least 2 weeks. As used herein, the term “room temperature” is used to refer to the temperature range of about 20° C. to about 23.5° C. At the end of this period, the sample is placed in a Differential Scanning calorimeter (TA Instruments Model 2920 DSC) and cooled to about −50° C. to about −70° C. at a cooling rate of about 10° C./min. The sample is heated at 10° C./min to attain a final temperature of about 200° C. to about 220° C. The thermal output is recorded as the area under the melting peak of the sample which is typically peaked at about 30° C. to about 175° C. and occurs between the temperatures of about 0° C. and about 200° C. is a measure of the heat of fusion expressed in Joules per gram of polymer. The melting point is recorded as the temperature of the greatest heat absorption within the range of melting of the sample.

The propylene-based elastomer may have a density of about 0.850 to about 0.900 g/cm³, or about 0.860 to about 0.880 g/cm³, at room temperature as measured based on ASTM D1505.

The propylene-based elastomer may have a fractional melt flow rate, as measured based on ASTM D1238, 2.16 kg at 230° C., of at least about 0.5 g/10 min. In some embodiments, the propylene-based elastomer may have a fractional melt flow rate of about 0.5 to about 20 g/10 min, or about 2 to about 18 g/10 min.

The propylene-based elastomer may have an Elongation at Break of less than about 2000%, less than about 1800%, less than about 1500%, or less than about 1000%, as measured based on ASTM D638.

In some embodiments, the propylene-based elastomer is an elastomer including propylene-crystallinity, a melting point by DSC equal to or less than 105° C., and a heat of fusion of from about 5 J/g to about 45 J/g. The propylene-derived units are present in an amount of about 80 to about 90 wt %, based on the total weight of the propylene-based elastomer. The ethylene-derived units are present in an amount of about 8 to about 18 wt %, for example, about 8, about 8.5, about 9, about 9.5, about 10, about 10.5, about 11, about 11.5, about 12, about 12.5, about 13, about 13.5, about 14, about 14.5, about 15, about 15.5, about 16, about 16.5, about 17, about 17.5, about 18 wt %, based on the total weight of the propylene-based elastomer.

The compositions disclosed herein may include one or more different propylene-based elastomers, i.e., propylene-based elastomers each having one or more different properties such as, for example, different comonomer or comonomer content. Such combinations of various propylene-based elastomers are all within the scope of the invention.

Suitable propylene-based elastomers may be available commercially under the trade names VISTAMAXX™ (ExxonMobil Chemical Company, Houston, Tex., USA), VERSIFY™ (The Dow Chemical Company, Midland, Mich., USA), certain grades of TAFMER™ XM or NOTIO™ (Mitsui Company, Japan), and certain grades of SOFTEL™ (Basell Polyolefins, Netherlands). The particular grade(s) of commercially available propylene-based elastomer suitable for use in the invention can be readily determined using methods commonly known in the art.

### Ethylene Polymers

The multilayer film made by the method described herein the outer layer comprises from about 50 to about 100 wt % of a polyethylene.

In one aspect of the invention, the ethylene polymers are selected from ethylene homopolymers, ethylene copolymers, and compositions thereof. Useful copolymers comprise one or more comonomers in addition to ethylene and can be a random copolymer, a statistical copolymer, a block copolymer, and/or compositions thereof. The method of making the polyethylene is not critical, as it can be made by slurry, solution, gas phase, high pressure or other suitable processes, and by using catalyst systems appropriate for the polymerization of polyethylenes, such as Ziegler-Natta-type catalysts, chromium catalysts, metallocene-type catalysts, other appropriate catalyst systems or combinations thereof, or by free-radical polymerization. In a preferred embodiment, the ethylene polymers are made by the catalysts, activators and processes described in U.S. Pat. Nos. 6,342,566; 6,384,142; 5,741,563; and PCT Publication Nos. WO 03/040201; and WO 97/19991. Such catalysts are well known in the art, and are described in, for example, ZIEGLER CATALYSTS (Gerhard Fink, Rolf Mülhaupt and Hans H. Brintzinger, eds., Springer-Verlag 1995); Resconi et al.; and I, II METALLOCENE-BASED POLYOLEFINS (Wiley & Sons 2000).

Ethylene polymers and copolymers that are useful in this invention include those sold by ExxonMobil Chemical Company in Houston Tex., including HDPE, LLDPE, and LDPE; and those sold under the ENABLE™, EXACT™, EXCEED™, ESCORENE™ EXXCO™, ESCOR™, PAXON™, and OPTEMA™ tradenames.

Preferred ethylene homopolymers and copolymers useful in this invention typically have:

1. an M_{w} of 20,000 g/mol or more, 20,000 to 2,000,000 g/mol, preferably 30,000 to 1,000,000, preferably 40,000 to 200,000, preferably 50,000 to 750,000, as measured by size exclusion chromatography; and/or
2. an M_{w}/Mₙ of 1 to 40, preferably 1.6 to 20, or 8 to 25, more preferably 1.8 to 10, more preferably 1.8 to 4, as measured by size exclusion chromatography; and/or
3. a Tₘ of 30° C. to 150° C., preferably 30° C. to 140° C., preferably 50° C. to 140° C., more preferably 60° C. to 135° C., as determined based on ASTM D3418-03; and/or
4. a crystallinity of 5% to 80%, preferably 10% to 70%, more preferably 20% to 60%, preferably at least 30%, or at least 40%, or at least 50%, as determined based on ASTM D3418-03; and/or
5. a heat of fusion of 300 J/g or less, preferably 1 to 260 J/g, preferably 5 to 240 J/g, preferably 10 to 200 J/g, as determined based on ASTM D3418-03; and/or
6. a crystallization temperature (T_{c}) of 15° C. to 130° C., preferably 20° C. to 120° C., more preferably 25° C. to 110° C., preferably 60° C. to 125° C., as determined based on ASTM D3418-03; and/or
7. a heat deflection temperature of 30° C. to 120° C., preferably 40° C. to 100° C., more preferably 50° C. to 80° C. as measured based on ASTM D648 on injection molded flexure bars, at 66 psi load (455 kPa); and/or
8. a Shore hardness (D scale) of 10 or more, preferably 20 or more, preferably 30 or more, preferably 40 or more, preferably 100 or less, preferably from 25 to 75 (as measured based on ASTM D 2240); and/or
9. a percent amorphous content of at least 50%, preferably at least 60%, preferably at least 70%, more preferably between 50% and 95%, or 70% or less, preferably 60% or less, preferably 50% or less as determined by subtracting the percent crystallinity from 100; and/or
10. a branching index (g′vis) of 0.97 or more, preferably 0.98 or more, preferably 0.99 or more, preferably 1; and/or
11. a density of about 0.860 to about 0.980 g/cm³ (preferably from 0.880 to 0.960 g/cm³, preferably from 0.910 to 0.940 g/cm³, preferably from 0.915 to 0.930 g/cm³) determined based on ASTM D 1505 using a density-gradient column on a compression-molded specimen that has been slowly cooled to room temperature (i.e. over a period of 10 minutes or more) and allowed to age for a sufficient time that the density is constant within +/−0.001 g/cm³.

The polyethylene may be an ethylene homopolymer, such as HDPE. In one embodiment, the ethylene homopolymer has a molecular weight distribution (M_{w}/Mₙ) of up to 40, preferably ranging from 1.5 to 20, or from 1.8 to 10, or from 1.9 to 5, or from 2.0 to 4. In another embodiment, the 1% secant flexural modulus (determined based on ASTM D790A, where test specimen geometry is as specified under the ASTM D790 section “Molding Materials (Thermoplastics and Thermosets),” and the support span is 2 inches (5.08 cm)) of the ethylene polymer falls in a range of 200 to 1000 MPa, and from 300 to 800 MPa in another embodiment, and from 400 to 750 MPa in yet another embodiment, wherein a desirable polymer may exhibit any combination of any upper flexural modulus limit with any lower flexural modulus limit. The melt index (MI) of preferred ethylene homopolymers range from 0.05 to 800 dg/min in one embodiment, and from 0.1 to 100 dg/min in another embodiment, as measured based on ASTM D1238 (190° C., 2.16 kg).

In a preferred embodiment, the polyethylene comprises less than 20 mol % propylene units (preferably less than 15 mol %, preferably less than 10 mol %, preferably less than 5 mol %, and preferably 0 mol % propylene units).

In another embodiment of the invention, the ethylene polymer useful herein is produced by polymerization of ethylene and, optionally, an alpha-olefin with a catalyst having, as a transition metal component, a bis(n-C₃₋₄ alkyl cyclopentadienyl) hafnium compound, wherein the transition metal component preferably comprises from about 95 mol % to about 99 mol % of the hafnium compound as further described in U.S. Pat. No. 9,956,088.

In another embodiment of the invention, the ethylene polymer is an ethylene copolymer, either random or block, of ethylene and one or more comonomers selected from C₃ to C₂₀ α-olefins, typically from C₃ to C₁₀ α-olefins. Preferably, the comonomers are present from 0.1 wt % to 50 wt % of the copolymer in one embodiment, and from 0.5 wt % to 30 wt % in another embodiment, and from 1 wt % to 15 wt % in yet another embodiment, and from 0.1 wt % to 5 wt % in yet another embodiment, wherein a desirable copolymer comprises ethylene and C₃ to C₂₀ α-olefin derived units in any combination of any upper wt % limit with any lower wt % limit described herein. Preferably the ethylene copolymer will have a weight average molecular weight of from greater than 8,000 g/mol in one embodiment, and greater than 10,000 g/mol in another embodiment, and greater than 12,000 g/mol in yet another embodiment, and greater than 20,000 g/mol in yet another embodiment, and less than 1,000,000 g/mol in yet another embodiment, and less than 800,000 g/mol in yet another embodiment, wherein a desirable copolymer may comprise any upper molecular weight limit with any lower molecular weight limit described herein.

In another embodiment, the ethylene copolymer comprises ethylene and one or more other monomers selected from the group consisting of C₃ to C₂₀ linear, branched or cyclic monomers, and in some embodiments is a C₃ to C₁₂ linear or branched alpha-olefin, preferably butene, pentene, hexene, heptene, octene, nonene, decene, dodecene, 4-methyl-pentene-1,3-methyl pentene-1,3,5,5-trimethyl-hexene-1, and the like. The monomers may be present at up to 50 wt %, preferably from 0 wt % to 40 wt %, more preferably from 0.5 wt % to 30 wt %, more preferably from 2 wt % to 30 wt %, more preferably from 5 wt % to 20 wt %, based on the total weight of the ethylene copolymer.

Preferred linear alpha-olefins useful as comonomers for the ethylene copolymers useful in this invention include C₃ to C₈ alpha-olefins, more preferably 1-butene, 1-hexene, and 1-octene, even more preferably 1-hexene. Preferred branched alpha-olefins include 4-methyl-1-pentene, 3-methyl-1-pentene, 3,5,5-trimethyl-1-hexene, and 5-ethyl-1-nonene. Preferred aromatic-group-containing monomers contain up to 30 carbon atoms. Suitable aromatic-group-containing monomers comprise at least one aromatic structure, preferably from one to three, more preferably a phenyl, indenyl, fluorenyl, or naphthyl moiety. The aromatic-group-containing monomer further comprises at least one polymerizable double bond such that after polymerization, the aromatic structure will be pendant from the polymer backbone. The aromatic-group containing monomer may further be substituted with one or more hydrocarbyl groups including but not limited to C₁ to C₁₀ alkyl groups. Additionally, two adjacent substitutions may be joined to form a ring structure. Preferred aromatic-group-containing monomers contain at least one aromatic structure appended to a polymerizable olefinic moiety. Particularly, preferred aromatic monomers include styrene, alpha-methylstyrene, para-alkylstyrenes, vinyltoluenes, vinylnaphthalene, allyl benzene, and indene, especially styrene, paramethyl styrene, 4-phenyl-1-butene and allyl benzene.

Preferred diolefin monomers useful in this invention include any hydrocarbon structure, preferably C₄ to C₃₀, having at least two unsaturated bonds, wherein at least two of the unsaturated bonds are readily incorporated into a polymer by either a stereospecific or a non-stereospecific catalyst(s). It is further preferred that the diolefin monomers be selected from alpha, omega-diene monomers (i.e., di-vinyl monomers). More preferably, the diolefin monomers are linear di-vinyl monomers, most preferably those containing from 4 to 30 carbon atoms. Examples of preferred dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, particularly preferred dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Preferred cyclic dienes include cyclopentadiene, vinylnorbornene, norbornadiene, ethylidene norbornene, divinylbenzene, dicyclopentadiene, or higher ring containing diolefins with or without substituents at various ring positions.

In a preferred embodiment, one or more dienes are present in the ethylene polymer at up to 10 wt %, preferably at 0.00001 wt % to 2 wt %, preferably 0.002 wt % to 1 wt %, even more preferably 0.003 wt % to 0.5 wt %, based upon the total weight of the ethylene polymer. In some embodiments diene is added to the polymerization in an amount of from an upper limit of 500 ppm, 400 ppm, or 300 ppm to a lower limit of 50 ppm, 100 ppm, or 150 ppm.

Preferred ethylene copolymers useful herein are preferably a copolymer comprising at least 50 wt % ethylene and having up to 50 wt %, preferably 1 wt % to 35 wt %, even more preferably 1 wt % to 6 wt % of a C₃ to C₂₀ comonomer, preferably a C₄ to C₈ comonomer, preferably hexene or octene, based upon the weight of the copolymer. The polyethylene copolymers preferably have a composition distribution breadth index (CDBI) of 60% or more, preferably 60% to 80%, preferably 65% to 80%. In another preferred embodiment, the ethylene copolymers have a CDBI of 60% to 80%, preferably between 65% and 80%. Preferably these polymers are metallocene polyethylenes (mPEs).

Useful mPE homopolymers or copolymers may be produced using mono- or bis-cyclopentadienyl transition metal catalysts in combination with an activator of alumoxane and/or a non-coordinating anion in solution, slurry, high pressure or gas phase. The catalyst and activator may be supported or unsupported and the cyclopentadienyl rings may be substituted or unsubstituted. Several commercial products produced with such catalyst/activator combinations are commercially available from ExxonMobil Chemical Company in Baytown, Tex. under the tradename EXCEED™ Polyethylene or ENABLE™ Polyethylene.

In one embodiment, the 1% secant flexural modulus of preferred ethylene polymers ranges from 5 MPa to 1000 MPa, preferably from 100 MPa to 800 MPa in another embodiment, and from 10 MPa to 300 MPa in yet another embodiment, wherein a desirable polymer may exhibit any combination of any upper flexural modulus limit with any lower flexural modulus limit.

The crystallinity of the polymer may also be expressed in terms of crystallinity percent. The thermal energy for the highest order of polyethylene is estimated at 290 J/g. That is, 100% crystallinity is equal to 290 J/g. Preferably, the polymer has a crystallinity (as determined by DSC) within the range having an upper limit of 80%, 60%, 40%, 30%, or 20%, and a lower limit of 1%, 3%, 5%, 8%, or 10%. Alternately, the polymer has a crystallinity of 5% to 80%, preferably 10% to 70, more preferably 20% to 60%. Alternatively the polyethylene may have a crystallinity of at least 30%, preferably at least 40%, alternatively at least 50%, where crystallinity is determined.

The level of crystallinity may be reflected in the melting point. In one embodiment of the present invention, the ethylene polymer has a single melting point. Typically, a sample of ethylene copolymer will show secondary melting peaks adjacent to the principal peak, which is considered together as a single melting point. The highest of these peaks is considered the melting point. The polymer preferably has a melting point (as determined by DSC) ranging from an upper limit of 150° C., 130° C. or 120° C. to a lower limit of 35° C., 40° C., or 45° C.

In particular, the ethylene polymer compositions described herein present in at least one outer layer may be physical blends or in situ blends of more than one type of ethylene polymer or compositions of ethylene polymers with polymers other than ethylene polymers where the ethylene polymer component is the majority component, e.g., greater than 50 wt % of the total weight of the composition. Preferably, the average density of the at least one outer layer ranges from about 0.918 g/cm³ to about 0.927 g/cm³, or from about 0.919 g/cm³ to about 0.925 g/cm³. Preferably, the ethylene polymer composition is a blend of two polyethylenes with different densities. The weight ratio between the polyethylene of a higher density and the polyethylene of a lower density may be about 1:2 to about 1:5, for example, about 1:2, about 1:2.5, about 1:3, about 1:3.5, about 1:4, about 1:4.5, or about 1:5.

In a preferred embodiment, the multilayer film made by the inventive method described herein comprises at least one inner layer between each outer layer and the core layer. The multilayer film can also comprise in at least one inner layer an ethylene polymer composition described herein, preferably in the form of a blend of two polyethylenes. Preferably, at least one inner layer has a density higher than that of the outer layer.

### Additives

The film made by the method of the present invention may also contain various additives as is generally known in the art. Examples of such additives include an antioxidant, an ultraviolet light stabilizer, a thermal stabilizer, a slip agent, an antiblock, a pigment, a processing aid, a crosslinking catalyst, a flame retardant, a filler and a foaming agent, etc. In a preferred embodiment, the additives may each individually present at 0.01 wt % to 50 wt %, or from 0.01 wt % to 10 wt %, or from 0.1 wt % to 6 wt %, based upon the weight of the film.

### Coextrusion Processes

The present invention generally relates to blown film extrusion and especially coextrusion methods. The term coextrusion in the specification and claims refers to an extrusion process where at least two same or different molten polymer compositions are extruded and bonded together in a molten condition in the die exit. A bubble is blown up by internal air supply Films are formed, while cooling progressively, after a complex interplay of stretching, orientation and crystallization until the film reaches a take-up device enclosing the top of the bubble, such as a pair of pinch rollers, and the bubble is split into two parts followed by being wound around two winders.

In blown film extrusion, the film may be pulled upwards by, for example, pinch rollers after exiting from the die and is simultaneously inflated and stretched transversely sideways to an extent that can be quantified by the blow up ratio (BUR). The inflation provides the transverse direction (TD) stretch, while the upwards pull by the pinch rollers provides a machine direction (MD) stretch. As the polymer cools after exiting the die and inflation, it crystallizes and a point is reached where crystallization in the film is sufficient to prevent further MD or TD orientation. The location at which further MD or TD orientation stops is generally referred to as the “frost line” because of the development of haze at that location.

Variables in this process that determine the ultimate film properties include the die gap, the BUR and TD stretch, the take up speed and MD stretch and the frost line height. Certain factors tend to limit production speed and are largely determined by the polymer rheology including the shear sensitivity which determines the maximum output and the melt tension which limits the bubble stability, BUR and take up speed.

### Film Structures

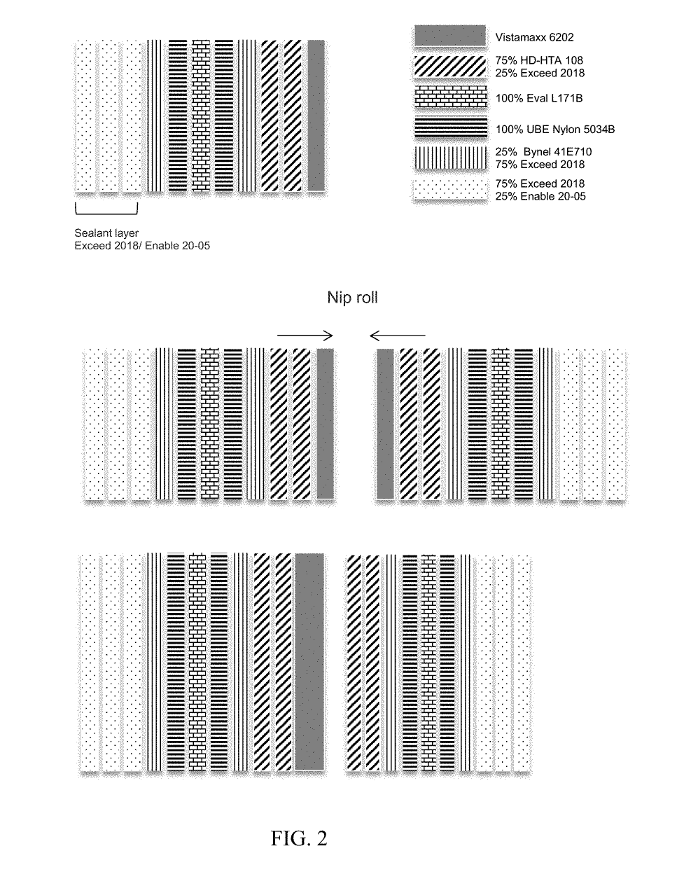

The film made as described herein may have an A/B/C/D/E/F/G/H/I/J/K structure wherein K is an outer layer that will be located at the inside of the bubble after the coextrusion process and previously to the collapsing of the bubble at the nip roll. The composition of this layer comprises a Vistamaxx™ performance polymer, e.g., Vistamaxx 6202FL. The layers D, E, F, G, H are located at the center of the multilayer structure and comprise the barrier polymers and tie resin (i.e., anhydride-modified linear low density polyethylene). The composition of layers D and H comprises a blend of maleic anhydride grafted polymer, e.g., Amplify™ 1057 from DOW or Bynel® 41E710 from Dupont, with a linear low density polyethylene at a blend ratio of 75/25%. The composition of layers E and G comprises a PA 6/66 copolyamide, e.g., UBE Nylon 5034B or Ultramide®C40L from BASF (while the copolyamide was used in the examples of the invention, homopolyamides may also be used). The composition of layer F is an ethylene vinyl alcohol copolymer, e.g., Eval™L171B (while Eval L171B was used in the examples of the invention, other ethylene vinyl alcohol copolymers may be suitable for use in the presently described films). The composition of layers I and J, sub-skin layers, is similar and comprises a blend of high density polyethylene and low density polyethylene at a blend ratio of 75/25% (not counting with slip). After collapsing of the bubble at the nip roll the layer K will become located at the center of the multilayer structure that will have a total of 21 layers. The remaining layers will be located within the multilayer structure as represented on FIG. 2.

In particular, the film may have improved mechanical properties including at least one of the following: (a) a stiffness (1% Secant Modulus) at least about 20% lower than that of a comparative film in both the Machine Direction (MD) and the Transverse Direction (TD); (b) a dart impact at least about 50% higher than that of a comparative film; and (c) an Elmendorf tear strength at least about 10% higher than that of a comparative film in the Machine Direction (MD), without significantly compromised optical properties, preferably even accompanied by a haze reduced by at least about 20%, in comparison with a comparative film.

In multilayer constructions, other layer(s) between the core layer and the outer layers may be any layer typically included in multilayer film structures. For example, the other layer or layers may be:

1. Polyolefins. Preferred polyolefins include homopolymers or copolymers of C₂ to C₄₀ olefins, preferably C₂ to C₂₀ olefins, preferably a copolymer of an α-olefin and another olefin or α-olefin (ethylene is defined to be an α-olefin for purposes of this invention). Preferably homopolyethylene, homopolypropylene, propylene copolymerized with ethylene and/or butene, ethylene copolymerized with one or more of propylene, butene or hexene, and optional dienes. Preferred examples include thermoplastic polymers such as ultra-low density polyethylene, very low density polyethylene, linear low density polyethylene, low density polyethylene, medium density polyethylene, high density polyethylene, polypropylene, isotactic polypropylene, highly isotactic polypropylene, syndiotactic polypropylene, random copolymer of propylene and ethylene, and/or butane, and/or hexene, elastomers such as ethylene propylene rubber, ethylene propylene diene monomer rubber, neoprene, and compositions of thermoplastic polymers and elastomers, such as, for example, thermoplastic elastomers and rubber toughened plastics.
2. Polar polymers. Preferred polar polymers include homopolymers and copolymers of esters, amides, acetates, anhydrides, copolymers of a C₂ to C₂₀ olefin, such as ethylene and/or propylene and/or butene with one or more polar monomers such as acetates, anhydrides, esters, alcohol, and/or acrylics. Preferred examples include polyesters, polyamides, ethylene vinyl acetate copolymers, and polyvinyl chloride.
3. Cationic polymers. Preferred cationic polymers include polymers or copolymers of geminally disubstituted olefins, α-heteroatom olefins and/or styrenic monomers. Preferred geminally disubstituted olefins include isobutylene, isopentene, isoheptene, isohexane, isooctene, isodecene, and isododecene. Preferred α-heteroatom olefins include vinyl ether and vinyl carbazole, preferred styrenic monomers include styrene, alkyl styrene, para-alkyl styrene, α-methyl styrene, chloro-styrene, and bromo-para-methyl styrene. Preferred examples of cationic polymers include butyl rubber, isobutylene copolymerized with para methyl styrene, polystyrene, and poly-α-methyl styrene.
4. Miscellaneous. Other preferred layers can be paper, wood, cardboard, metal, metal foils (such as aluminum foil and tin foil), metallized surfaces, glass (including silicon oxide (SiOₓ) coatings applied by evaporating silicon oxide onto a film surface), fabric, spunbond fibers, and non-wovens (particularly polypropylene spunbond fibers or non-wovens), and substrates coated with inks, dyes, pigments, and the like.

In particular, the multilayer film prepared by the inventive method described herein can also include layers comprising materials such as ethylene vinyl alcohol (EVOH), polyamide (PA), or polyvinylidene chloride (PVDC), so as to obtain barrier performance for the film.

The thickness of the films may range from 5 to 200 μm in general and is largely determined by the intended use and properties of the film. Stretch films may be thin; those for shrink films or heavy duty bags are much thicker. Conveniently the film has a thickness of from 5 to 200 μm, preferably from 10 to 150 μm, and more preferably from 20 to 80 μm. The thickness of each of the outer layers may be at least 7% of the total thickness, preferably from 10 to 40%. The core layer may be less than about 40%, preferably from about 15% to about 30%, of the total volume (thickness) of the film.

Films with high clarity may be provided having a thickness from 10-80 μm preferably with an A/B/X/B/A structure. The outer (A) layer composition and the inner (B) layer composition may preferably both consist substantially of linear polyethylene, such as metallocene LLDPE (mLLDPE), and the core (X) layer may consist substantially of a propylene-based elastomer as described herein. Suitably, the core layer may be present in an amount of about 15% to about 30% of the total volume (thickness) of the film. Preferably, the outer layer contains a blend of two mLLDPEs, having an average density of 0.919 g/cm³ to about 0.925 g/cm³. The inner layer also contains a blend of two mLLDPEs, showing an average density of at least about 0.006 g/cm³ higher than that of the outer layer.

Films with barrier properties may be provided with an A/B/C/D/E/F/G/H/I/J/K structure. The outer (A) layer composition may preferably both consist substantially of linear polyethylene and the core (K) layer may consist substantially of a propylene-based elastomer as described herein. Suitably, C layer may be primarily made of barrier materials, such as EVOH or PA, and B and D layers may be chemically modified resins, such as a graft LLDPE, serving as tie layers used to bond the polar barrier materials to the core and outer layers. Enhanced barrier performance can also be expected if the inventive method is applied to make such films.

The films prepared according to the present invention may be used in high barrier flexible food packaging applications, e.g., to pack fresh and processed meat, matured and no-matured cheese, fresh fish, vegetables, bag in box applications. A package comprising a film prepared by the method described herein can be heat sealed around package content. The film and package can display outstanding optical properties as demonstrated by high clarity and low haze, high bending stiffness and exceptional Elmendorf tear.

### EXAMPLES

The present invention, while not meant to be limited by, may be better understood by reference to the following examples and tables.

Exceed™ 2018 HA is a metallocene-catalyzed ethylene-hexene copolymer, commercially available from ExxonMobil Chemical Company, having a density of 0.918 g/cm³, melt index (190° C., 2.16 kg) of 2.0 g/10 min, and peak melting temperature of 117° C. Enable™ 20-05 is a metallocene-catalyzed ethylene-hexene copolymer, commercially available from ExxonMobil Chemical Company, having a density of 0.92 g/cm³, melt index (190° C., 2.16 kg) of 0.5 g/10 min, and a peak melting temperature of 114° C. HTA 108 is a homopolymer high density polyethylene film grade resin, commercially available from ExxonMobil Chemical Company, having a density of 0.961 g/cm³, melt index (190° C., 2.16 kg) of 0.7 g/10 min, melt flow rate of 46 g/10 min, and softening temperature of 127° C. Exceed™ 1012 HA mVLDPE is a metallocene-catalyzed ethylene-hexene copolymer, commercially available from ExxonMobil Chemical Company, having a density of 0.912 g/cm³, melt index (190° C., 2.16 kg) of 1.0 g/10 min, and a peak melting temperature of 115° C. Exceed™ 3812CB is a metallocene-catalyzed ethylene-hexene copolymer, commercially available from ExxonMobil Chemical Company, having a density of 0.912 g/cm³, melt index (190° C., 2.16 kg) of 3.8 g/10 min, and a peak melting temperature of 110° C. Vistamaxx™ 6202 performance polymer is a metallocene-catalyzed propylene-ethylene copolymer, commercially available from ExxonMobil Chemical Company, having a density of 0.863 g/cm³, melt index (190° C., 2.16 kg) of 9.1 g/10 min, melt flow rate of 20 g/10 min, and ethylene content of 15 wt %. UBE Nylon 5034B is a PA6/6.6 copolyamide commercially available from UBE Engineering Plastics S.A. Eval™ L171B is a 27 mol % ethylene vinyl alcohol copolymer commercially available from Kuraray Co., Ltd. Bynel® 41E710 is an anhydride-modified linear low density polyethylene resin commercially available from Dupont.

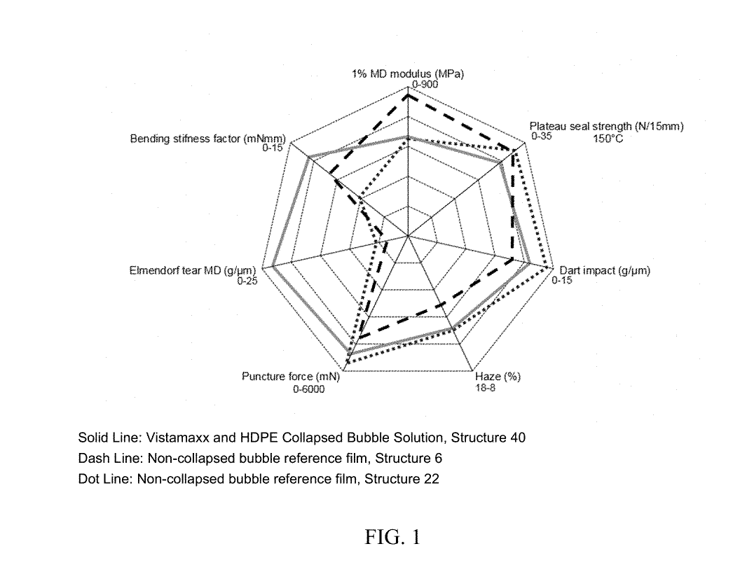

Films were produced in an 11 layer co-extrusion blown line with 11 extruders having a die gap of 1.8 and a blow up ratio (BUR) of 2. The films each have a thickness of 77 μm and were produced at an output of 465 kg/min. The layer distribution for the films is 1/1/1/1/1/1/1/1/1/1/1. The film formulations and processing details for the inventive and comparative films can be found in the following tables. The films were evaluated for various properties, as illustrated in FIG. 1. The test methods used to measure those properties are provided below.

Clarity is measured based on ASTM D-1746. Drop Impact Tester is measured based on ASTM D-2463. Elmendorf tear strength is measured based on ASTM D-1922-09. Film stiffness by two-point bending method is measured based on DIN 53121. Gloss 45° is measured based on ASTM D-2457. Heat seal force is measured based on ASTM F-88. Hot tack testing is measured based on ASTM F-1921. Impact resistance by free-falling dart is measured based on ASTM D-1709. Puncture needle test is measured based on CEN 14477. Seal strength sample preparation is based on ASTM F-2029. Tensile properties are measured based on ASTM D-882-02. Total haze measurement is based on ASTM D-1003.

FIG. 2 depicts the collapsed bubble structure of the inventive 11 layer film of Table 1 (Film 3). Each of the layers of the film is 3.5 μm thick. The first image of FIG. 2 illustrates the 11 layer Film 2 prior to collapsing of the bubble. The second image of FIG. 2 illustrates the film at the nip roll. The total thickness of the film is 77 μm. The third image of FIG. 2 illustrates the film after collapsing the bubble at the nip roll. The layer with Vistamaxx 6202 has a thickness of 7 μm, all other layers have a thickness of 3.5 μm. The total thickness of the film is 77 μm and the total number of layers of the film is 21.

As indicated in Tables 1-3 and FIG. 1, the inventive collapsed bubble film provides a favorably higher Elmendorf tear and bending stiffness than the comparative film without compromising on puncture resistance, dart impact, and optical properties.

All documents described herein are incorporated by reference herein, including any priority documents and/or testing procedures. When numerical lower limits and numerical upper limits are listed herein, ranges from any lower limit to any upper limit are contemplated. As is apparent from the foregoing general description and the specific embodiments, while forms of the invention have been illustrated and described, various modifications can be made without departing from the spirit and scope of the invention. Accordingly, it is not intended that the invention be limited thereby.

TABLE 1
Film Formulations (wt %)

| | Layer A | Layer B | Layer C | Layer D | Layer E | Layer F | Layer G | Layer H | Layer I | Layer J | Layer K |
|---|---|---|---|---|---|---|---|---|---|---|---|
| Film | 75% | 75% | 75% | 75% | UBE | Eval ™ | UBE | 75% | 75% | 75% | 75% |
| 1 | Exceed | Exceed | Exceed | Exceed | Nylon | L171B | Nylon | Exceed | Exceed | Exceed | Exceed |
| | 2018HA/ | 2018HA/ | 2018HA/ | 2018HA/ | 5034B | | 5034B | 2018HA/ | 2018HA/ | 2018HA/ | 2018HA/ |
| | 25% | 25% | 25% | 25% | | | | 25% | 22% | 22% | 20% |
| | Enable | Enable | Enable | Bynel | | | | Bynel | Enable | Enable | Enable |
| | 20-05 | 20-05 | 2005 | 41E710 | | | | 41E710 | 20-05/ | 20-05/ | 20-05/ |
| | | | | | | | | | 3% Slip | 3% Slip | 3% Slip |
| | | | | | | | | | Masterbatch | Masterbatch | Masterbatch/ |
| | | | | | | | | | | | 2% Antiblock |
| | | | | | | | | | | | Masterbatch |
| Film | | 75% | | | | | | | | 75% | 75% |
| 2 | | HTA | | | | | | | | HTA | Exceed |
| | | 108/ | | | | | | | | 108/ | 1012HA/ |
| | | 25% | | | | | | | | 22% | 20% |
| | | Exceed | | | | | | | | Exceed | Exceed |
| | | 2018HA | | | | | | | | 2018HA/ | 3812CB/ |
| | | | | | | | | | | 3% Slip | 3% Slip |
| | | | | | | | | | | Masterbatch | Masterbatch/ |
| | | | | | | | | | | | 2% Antiblock |
| | | | | | | | | | | | Masterbatch |
| Film | | 75% | | | | | | | 75% | 75% | 100% |
| 3 | | Exceed | | | | | | | HTA | HTA | Vistamaxx |
| | | 2018HA/ | | | | | | | 108/ | 108/ | 6202 |
| | | 25% | | | | | | | 22% | 22% | |
| | | Enable | | | | | | | Exceed | Exceed | |
| | | 20-05 | | | | | | | 2018HA/ | 2018HA/ | |
| | | | | | | | | | 3% Slip | 3% Slip | |
| | | | | | | | | | Masterbatch | Masterbatch | |

TABLE 2
Processing Conditions Used to Produce the Films

| | HTA | | | Line Speed | Cage | Air Ring |
|---|---|---|---|---|---|---|
| Film | 108 | Thickness of each Layer | Output | at Nip Roll | Height | Height |
| No. | wt % | (μm) | (kg/min) | (m/min) | (mm) | (mm) |
| 1 | 0 | 7/7/7/7/7/7/7/7/7/7 | 479 | 30 | 1607 | 74 |
| 2 | 13.6 | 7/7/7/7/7/7/7/7/7/7 | 480 | 30 | 1611 | 72 |
| 3 | 13.6 | 3.5/3.5/3.5/3.5/3.5/3.5/ | 465 | 60 | 1612 | 128 |
| | | 3.5/3.5/3.5/3.5/3.5 | | | | |

TABLE 3
Film Properties

| | Film No. | | |
|---|---|---|---|
| | 1 | 2 | 3 |
| Elmendorf Tear | | | |
| MD (g) | 435.0 | 282.6 | 1797.8 |
| MD, normalized (g/μm) | 5.4 | 3.6 | 23.1 |
| TD (g) | 580.6 | 546.2 | 2505.0 |
| TD, normalized (g/μm) | 7.3 | 7.1 | 32.1 |
| Needle Puncture | | | |
| Thickness (μm) | 81.0 | 78.0 | 78.0 |
| Max Force (mN) | 5678.0 | 4565.0 | 5267.0 |
| ε Max Force (mm) | 3.3 | 2.3 | 2.7 |
| F break (mN) | 5678.0 | 4563.0 | 5264.0 |
| ε break (mm) | 3.3 | 2.3 | 2.7 |
| Energy at Max Force (mJ) | 10.7 | 6.1 | 8.5 |
| Energy at Break (mJ) | 10.7 | 6.1 | 8.5 |
| F max, normalized (mN/μm) | 70.2 | 58.8 | 67.8 |
| F break, normalized (mN/μm) | 70.2 | 58.8 | 67.8 |
| Energy at F max, normalized (mJ/μm) | 0.1 | 0.08 | 0.1 |
| Energy at F break, normalized (mJ/μm) | 0.1 | 0.08 | 0.1 |
| Optical Properties | | | |
| Haze (%) | 11.0 | 12.9 | 11.1 |
| Clarity (%) | 68.0 | 58.0 | 53.0 |
| Gloss | 66.2 | 65.8 | 73.4 |
| Dart Impact | | | |
| WF (g) | 1138 | 881 | 1016 |
| W F/m (g/μm) | 14.2 | 10.8 | 12.6 |
| Tensile Properties | | | |
| Thickness MD (μm) | 79.3 | 79.9 | 75.3 |
| 10% Offset Yield Stress MD (MPa) | 19.2 | 22.4 | 19.5 |
| 1 ste Yield Stress MD (MPa) | 19.7 | 24.4 | 19.8 |
| Tensile Elongation at Yield Point MD (%) | 7.6 | 5.2 | 10.0 |
| Tensile Strength at Fmax MD (MPa) | 42.4 | 41.8 | 45.6 |
| Tensile Elongation at Fmax MD (%) | 418.0 | 429.0 | 396.0 |
| Tensile Strength at Break MD (MPa) | 42.4 | 41.8 | 45.6 |
| Tensile Elongation at Break MD (%) | 418.0 | 429.0 | 396.0 |
| 1% Modulus MD (MPa) | 584.0 | 850.0 | 600.0 |
| Energy at Break MD (mJ/mm³) | 105.0 | 111.0 | 108.0 |
| Thickness TD (μm) | 80.0 | 77.5 | 75.9 |
| 10% Offset Yield Stress TD (MPa) | 18.9 | 21.7 | 20.0 |
| 1 ste yield stress TD (MPa) | 19.3 | 24.0 | 20.8 |
| Tensile Elongation at Yield Point TD (%) | 8.1 | 5.4 | 7.3 |
| Tensile Strength at Fmax TD (MPa) | 44.1 | 40.3 | 47.0 |
| Tensile Elongation at Fmax TD (%) | 452.0 | 434.0 | 471.0 |
| Tensile Strength at Break TD (MPa) | 44.1 | 40.3 | 47.0 |
| Tensile Elongation at Break TD (%) | 452.0 | 434.0 | 471.0 |
| 1% Modulus TD (MPa) | 566.0 | 817.0 | 650.0 |
| Energy at Break TD (mJ/mm³) | 114.0 | 108.0 | 119.0 |
| Bending Stiffness | | | |
| Fmax (mN) | 87.9 | 151.7 | 183.2 |
| Fmax, normalized (mN/μm) | 1.1 | 1.9 | 2.4 |
| E mod (MPa) | 157.0 | 246.0 | 320.0 |
| Bending Stiffness Factor (mNmm) | 6.2 | 10.0 | 12.6 |
| Heat Seal | | | |
| Force | | | |
| (N/15 mm) | | | |
| at | — | 0.4/adhesive peeling | — |
| 90° C. | | | |
| at | 0.2/adhesive peeling | 4.1/adhesive peeling | 0.2/adhesive peeling |
| 100° C. | | | |
| at | 3.2/adhesive peeling | 23.4/delamination | 4.3/adhesive peeling |
| 110° C. | | with elongation | |
| at | 28.6/delamination | 30.2/delamination | 26.2/adhesive peeling with elongation |
| 120° C. | with elongation | with elongation | |
| at | 29.9/delamination | 31.1/delamination | 28.2/delamination with elongation |
| 130° C. | with elongation | with elongation | |
| at | 30.6/delamination | 31.3/delamination | 27.2/delamination with elongation |
| 140° C. | with elongation | with elongation | |
| at | 32.0/delamination | 31.4/delamination | 27.5/delamination with elongation |
| 150° C. | with elongation | with elongation | |
| at | 32.0/50:50 | 31.7/delamination | 27.9/delamination with elongation |
| 160° C. | delamination/edge | with elongation | |
| | break | | |
| at | 30.1/delamination | 36.3/material edge | 30.1/material edge break with |
| 170° C. | with elongation | break with elongation | elongation |
| at | 37.1/material edge | 36.8/material edge | 28.9/material edge break with |
| 180° C. | break with elongation | break with elongation | elongation |
| Hottack | | | |
| (N/30 mm) | | | |
| at | 0.8 | 0.6 | 0.6 |
| 70° C. | | | |
| at | 0.6 | 0.8 | 0.6 |
| 80° C. | | | |
| at | 0.7 | 0.7 | 0.7 |
| 90° C. | | | |
| at | 0.6 | 3.3 | 0.6 |
| 100° C. | | | |
| at | 7.9 | 12.5 | 4.4 |
| 110° C. | | | |
| at | 20.2 | 22.9 | 21.6 |
| 120° C. | | | |
| at | 20.3 | 21.3 | 21.8 |
| 130° C. | | | |
| at | 14.1 | 14.8 | 16.4 |
| 140° C. | | | |
| at | 8.4 | 7.7 | 9.3 |
| 150° C. | | | |
| at | 7.5 | 6.4 | 7.2 |
| 160° C. | | | |
| at | 6.6 | 6.1 | 7.0 |
| 170° C. | | | |
| at | 5.4 | 4.9 | 5.3 |
| 180° C. | | | |

What is claimed is:

1. A multilayer film, comprising:
(a) three inner layers, wherein the three innerlayers are adjacent to one another and one of the outermost inner layers (inner layer A) consists essentially of a propylene-based elastomer having at least about 60 wt % propylene-derived units and about 3 to about 25 wt % ethylene-derived units, based on total weight of the propylene-based elastomer, and a heat of fusion of less than about 80 J/g;
(b) three outer layers, wherein each outer layer comprises a blend of two polyethylenes; and
(c) five core layers, wherein the two outermost layers of the five core layers comprise of a blend of an ethylene copolymer and an anhydride-modified linear low-density polyethylene, the innermost layer of the five core layers consists essentially of ethylene vinyl alcohol, and the layers in between the outermost layers and the innermost layer of the five core layers consists essentially of a polyamide,
wherein the five core layers are in between the three inner layers and the three outer layers;
and wherein inner layer A is not adjacent to the five core layers.

2. The multilayer film of claim 1, wherein the two outermost layers of the five core layers is a blend of 25 wt % anhydride-modified linear low-density polyethylene and 75 wt % of an ethylene copolymer, based on the total weight of the outermost layer.

3. The multilayer film of claim 1, wherein each of the three outer layers has the same composition.

4. The multilayer film of claim 1, wherein the two inner layers, that are not inner layer A, have the same composition.

5. The multilayer film of claim 1, wherein each of the two inner layers, that are not inner layer A, is a blend of an ethylene homopolymer, an ethylene copolymer, and a slip masterbatch.

6. The multilayer film of claim 5, wherein each of the two inner layers, that are not inner layer A, is a blend of 75 wt % of the ethylene homopolymer, 22 wt % of the ethylene copolymer, and 3 wt % of the slip masterbatch, based on the total weight of each of the two inner layers.

7. The multilayer film of claim 1, wherein the thickness of each layer of the film is between about 1 mm and about 30 mm.

8. A collapsed bubble film comprising the multilayer film of claim 1.

9. The collapsed bubble film of claim 7, wherein the thickness of the inner layer A is twice the thickness of each layer in the film.

10. The collapsed bubble film of claim 9, wherein the film is symmetrical.

11. A multilayer film, comprising:
(a) an inner layer consisting essentially of a propylene-based elastomer having at least about 60 wt % propylene-derived units and about 3 to about 25 wt % ethylene-derived units, based on total weight of the propylene-based elastomer, and a heat of fusion of less than about 80 J/g;
(b) an outer layer comprising a blend of two polyethylenes; and
(c) a core layer further comprising five layers, wherein the two outermost layers of the five layers of the core layer is a blend of an ethylene copolymer and an anhydride-modified linear low-density polyethylene, the innermost layer of the five layers of the core layer consists essentially of ethylene vinyl alcohol, and the layers in between the outermost layers and the innermost layer of the core layer consists essentially of a polyamide,
wherein the core layer is in between the inner layer and the outer layer.
